(19) United States
(12) Patent Application Publication
(10) Pub. No.: US 2026/0228327 A1
(43) Pub. Date: Aug. 6, 2026

(54) METHOD FOR REMOTE FILE ISOLATION PROCESSING BASED ON WEB APPLICATION, AND COMPUTING DEVICE FOR THE SAME

(71) Applicant: NAMUSOFT CO., LTD, Seoul (KR)

(72) Inventor: Jonghyun WOO, Seoul (KR)

(73) Assignee: NAMUSOFT CO., LTD, Seoul (KR)

(21) Appl. No.: 19/063,514

(22) Filed: Feb. 26, 2025

(30) Foreign Application Priority Data
Feb. 4, 2025 (KR) 10-2025-0013469

(51) Int. Cl. G06F 21/53; G06F 21/31; G06F 21/54

(52) U.S. Cl. CPC G06F 21/53; G06F 21/31; G06F 21/54

(57) ABSTRACT

A method performed by a computing device according to an aspect of the present disclosure includes receiving a request to open a file stored in a local storage through a web application, in response to receiving the request to open the file, by an agent executed in the computing device, uploading the file to a remote storage, executing opening the file through the web application for the uploaded file, downloading a file processed through the web application from the remote storage, and updating the file stored in the local storage with the downloaded file.

### CROSS REFERENCE TO RELATED APPLICATION

This application claims the benefit of Korean Patent Applications No. 10-2025-0013469, filed on Feb. 4, 2025, in the Korean Intellectual Property Office, the disclosures of which are incorporated herein in its entirety by reference.

### BACKGROUND

### 1. Field

The present disclosure relates to a method for remote file isolation processing based on a web application, and a computing device for the same.

### 2. Description of the Related Art

In carrying out tasks based on computing devices such as desktop PCs, laptop PCs, tablet PCs, smartphones, etc., programs such as presentation, spreadsheet, word processing, and the like are routinely used. Recent cyber attacks related to files that are viewed, edited, or processed through these programs typically take the form of attaching malicious code to files that users routinely receive/view, and then inducing users to inadvertently open such files with programs installed on their computing devices. When the file is opened, an automatic execution script such as a macro enclosed with the file is executed, resulting in an attack on the computing device.

Additionally, recent cyber attacks may disguise file extensions to induce users to execute executable files. For example, an executable file (.exe) disguised as an Excel file or PDF may be executed on a computing device, potentially leading to the theft of data stored on the computing device or exposing the computing device to encryption attacks by ransomware.

Therefore, an alternative is required for safely viewing or editing files such as documents on a computing device.

### SUMMARY

The technical problem that the present disclosure aims to solve is to provide a method that can prevent cyber attacks on a computing device in advance by viewing or editing files in an environment isolated from the computing device, rather than viewing or directly executing files downloaded through email or the Internet, which may contain malicious code or be disguised as executable files, using applications installed on the user's computing device.

The technical objectives of the present disclosure are not limited to the problems mentioned above, and other objectives not mentioned will be clearly understood by those skilled in the art from the following description.

To achieve the above objectives, according to one aspect of the present disclosure, a method performed by a computing device is disclosed, comprising: receiving a request to open a file stored in a local storage through a web application; in response to receiving the request to open the file, by an agent executed in the computing device, uploading the file to a remote storage; executing opening the file through the web application for the uploaded file; downloading a file processed through the web application from the remote storage; and updating the file stored in the local storage with the downloaded file.

According to one embodiment, the receiving may comprise: receiving user input corresponding to a first action by a user for a file having an extension for which a default application is not set to the agent among files stored in the local storage; in response to the received user input, providing a service list including opening the file through the web application—wherein opening the file through the web application is a function provided by the agent; and receiving a request to open the file through the web application based on the service list.

According to one embodiment, the receiving may comprise: receiving user input corresponding to a second action by a user for a file having an extension for which a default application is set to the agent among files stored in the local storage.

According to one embodiment, the uploading may comprise: transmitting, by the agent, authentication information to the remote storage, the authentication information including at least one of an authentication token issued from the remote storage or a web application server, and account information of the user; and upon completion of authentication based on the transmitted authentication information, uploading the file to the remote storage.

According to one embodiment, the executing may comprise: providing, by the agent, connection information for executing opening the file through the web application for the uploaded file to the web application, and wherein the connection information includes at least one of location information of the uploaded file in the remote storage, and a URL of a web application server interoperating with the web application.

According to one embodiment, the executing may comprise: transmitting, by the agent, authentication information to a web application server, the authentication information including at least one of an authentication token issued from the remote storage or the web application server, and account information of the user; and upon completion of authentication based on the transmitted authentication information, the uploaded file being provided through the web application.

According to one embodiment, the executing may further comprise: activating an exclusive mode that restricts editing or deletion by applications other than the agent for the file stored in the local storage.

According to one embodiment, the updating may further comprise: deactivating the exclusive mode after the file stored in the local storage is updated with the downloaded file.

According to one aspect of the present disclosure, a non-transitory computer-readable storage medium storing a program for executing the above-described method is disclosed.

According to one aspect of the present disclosure, a computing device is disclosed, comprising: at least one processor; and a memory storing executable instructions for the at least one processor, wherein when the instructions are executed by the at least one processor, the at least one processor is configured to: receive a request to open a file stored in a local storage of the computing device through a web application—wherein opening the file through the web application is a function provided through an agent executed by the at least one processor, upload the file to a remote storage in response to receiving the request to open the file, execute opening the file through the web application for the uploaded file, download a file processed through the web application from the remote storage, and update the file stored in the local storage with the downloaded file.

### BRIEF DESCRIPTION OF THE DRAWINGS

A brief description of each drawing is provided to more fully understand the drawings recited in the detailed description of the present disclosure.

FIG. 1 is a simplified block diagram illustrating a system for a web application-based remote file isolation processing method according to the present disclosure.

FIG. 2 is a flowchart for explaining a remote file isolation processing method according to embodiments of the present disclosure.

FIG. 3 is a flowchart for explaining a file opening request operation according to embodiments of the present disclosure.

FIG. 4 is an example view of a file opening request operation according to Case 1 of FIG. 3.

FIG. 5 is a diagram for explaining an operation sequence in a system according to embodiments of the present disclosure.

### DETAILED DESCRIPTION

Various embodiments are described in more detail below with reference to the accompanying drawings, which form part of this specification and illustrate specific embodiments. However, the embodiments may be implemented in various different forms and should not be construed as being limited to the embodiments provided herein; rather, these embodiments are provided so that this disclosure will be thorough and complete, and will fully convey the scope of the embodiments to those skilled in the art. Embodiments may be implemented as methods, systems, or devices. Accordingly, embodiments may take the form of a hardware implementation, an implementation that is entirely software, or an implementation combining aspects of both software and hardware. Thus, the following detailed description is not to be taken in a limiting sense.

Hereinafter, embodiments of the present disclosure will be described in detail with reference to the accompanying drawings.

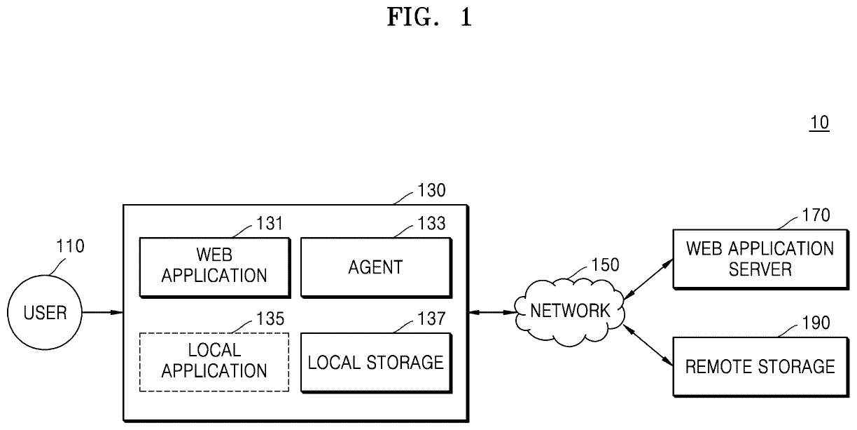

FIG. 1 is a simplified block diagram illustrating a system for a web application-based remote file isolation processing method according to the present disclosure. More specifically, the system 10 may be used to enable user 110 to view, edit, create, share, and publish files such as word processing documents, spreadsheet documents, presentation documents, image files, video files, and various other files based on web applications, while being isolated from malware and other malicious threats.

Referring to FIG. 1, the system 10 may include a computing device 130.

The computing device 130 may include a desktop or laptop computer, a tablet computer, a smartphone, a personal digital assistant (PDA), etc. The computing device 130 may be a kind of local device distinct from a web application server 170 and a remote storage 190 to be described later, but it is not necessarily so. The computing device 130 may include at least one processor and a memory storing executable instructions for the at least one processor. The at least one processor may be implemented as hardware such as a CPU, AP (application processor), MCU, GPU, NPU, integrated circuit, ASIC, FPGA, etc., and the memory may be composed of a storage medium or a combination of storage media such as ROM, RAM, flash memory, SSD, HDD, etc.

The computing device 130 may include, for example, a web application 131, an agent application 133 (hereinafter referred to as an agent), and may include an operating system that executes the exemplified applications.

The web application 131 may be a browser-based application that allows user 110 to perform certain tasks (viewing, editing, and/or saving, etc.) on files (such as document files) accessed using a browser or other web-based applications. For example, the web application 131 may include various applications such as cloud-based word processing applications, spreadsheet applications, presentation applications, image or video editing applications, etc.

The web application 131 may operate in conjunction with a web application server 170 through a network 150, thereby providing services related to file operations to user 110. For example, the web application 131 may provide the user 110 with services related to file operations provided by the web application server 170, and may obtain requests related to file operations (such as document editing requests) from the user 110, forward them to the web application server 170, and receive and display the results to the user 110. Meanwhile, the web application server 170 may perform operations such as file storage and retrieval in conjunction with the remote storage 190.

The agent 133 may correspond to an application that executes the remote file isolation processing method according to an embodiment of the present disclosure when user 110 performs file operations through the web application 131.

When user 110 opens or executes a file from the local storage 137 to work on it through the web application 131, the agent 133 may upload the file to the remote storage 190, and control the web application 131 to open or execute the uploaded file. According to an embodiment, the file may include various files created on the computing device 130 or downloaded via email, internet, etc., and stored in the local storage 137. According to an embodiment, the agent 133 may be configured to operate only on files existing in specific areas of the local storage 137 (e.g., local disk volumes (D:, E:, F:, etc.), folders (desktop, downloads, my documents, etc.)) or network drives (e.g., \\192.168.20.100, etc.).

The agent 133 may download a file processed (edited, etc.) through the web application 131 from the remote storage 190, and update the existing file stored in the local storage 137 with the downloaded file. Here, the processed file does not necessarily mean only a file that has completed processing, but may include a file obtained during the processing through the web application 131.

Additionally, when updating with the downloaded file, the agent 133 may create a copy of the original (existing file) with a different name according to a predefined rule in the same folder location or move the copy to a predefined backup space before updating the original, or may update the original file without creating a backup of the original.

Meanwhile, the agent 133 may be mounted in the form of a shell extension to a file manager, for example, Windows Explorer. In this case, the functions provided by the agent 133 may be listed in a context menu displayed when a user selects a specific file and performs a certain input (e.g., right-clicking with a mouse), and may be provided when the user selects an item for the desired function (e.g., open in web editing mode, online document editing, cloud document editor, etc.).

Accordingly, various functions of the agent 133, such as file opening, opening in web editing mode, file creation, etc., may be provided as context menu items and executed in response to selection of user 110. In some embodiments, some functions of the agent 133, such as opening in web editing mode, may also be automatically executed when access to document files with specific extensions is detected.

In this case, when user 110 selects new file creation through a context menu expressed by right-clicking at a specific folder location, a new file with a default name (new document.doc, new slide.ppt, etc.) may be created on the local storage, and the agent 133 may upload the created file to a remote cloud server, etc., and allow access through a web application. Alternatively, after receiving a name of a new file to be created on the local disk, the agent may create a file with the name and upload the created file to the remote storage 190.

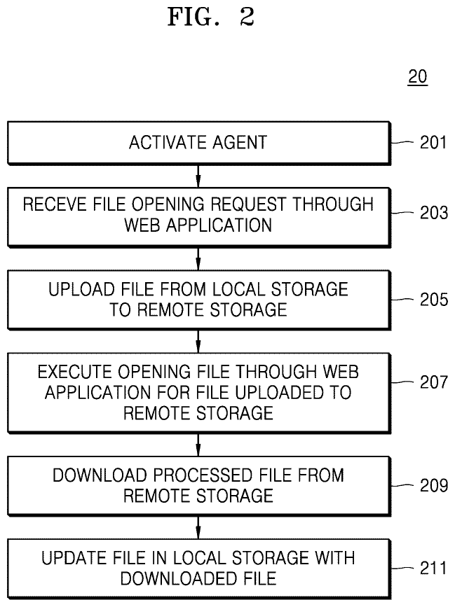

The remote document processing method executed by the agent 133 and related configurations will be described in more detail below with reference to FIGS. 2 through 4.

According to an embodiment, the computing device 130 may further include a local application 135. The local application 135 may include various applications capable of performing certain tasks on files, such as word processing applications, spreadsheet applications, presentation applications, image editing applications, video editing applications, etc. The local application 135 may allow user 110 to create, open, edit, and save files in the local storage 137 or other work products without the aforementioned remote file isolation processing.

As shown in FIG. 1, the computing device 130 may include one or more local storages 137 that allow user 110 to store files locally. For example, using the local storage 137, user 110 may store a document at a specific location (e.g., a specific folder) on a hard drive or another storage device physically connected to the computing device 130, such as a USB storage device.

Additionally, the computing device 130 may be configured to access one or more remote storages 190 using a network connection 150, allowing user 110 to store a document using one or more remote storages 190. In one embodiment, the remote storage 190 may be a cloud computing storage service or other similar storage service. While specific examples have been provided, other types of storage may be used in combination with the embodiments disclosed in this specification.

FIG. 2 is a flowchart for explaining a remote file isolation processing method according to embodiments of the present disclosure. The remote file isolation processing method 20 shown in FIG. 2 may be implemented as at least a part of the agent 133 in the computing device 130. In the following description, FIG. 1 will be referenced together, and for convenience of explanation, it is assumed that each operation is performed by the computing device 130.

The method 20 may begin with an operation 201 of activating the agent 133 of the computing device 130.

To activate the agent 133, the computing device 130 may require user 110 to provide user credentials. The user credentials may include a user ID, password, or other input associated with and identifying a specific user. In one embodiment, the user credentials may be configured to be identical or similar to the credentials for activating and accessing the web application server 170, remote storage 190, etc.

In one embodiment, as evidence that the user credentials have been successfully authenticated at the web application server 170 or remote storage 190, etc., the web application server 170 or remote storage 190 may issue an authentication token for the corresponding user ID to the agent 133. This authentication token may be used when the agent 133 later uploads a file to the remote storage 190 and provides the web application 131 with a web application URL and the location information of the file in the remote storage that can access and process (edit, etc.) the file, to prove that a pre-authenticated user is requesting access to files in the web application server 170 and remote storage 190 by providing the user's authentication token together.

In one embodiment, the user credentials may not be necessary. For example, in the case where a single sign-on credential is used in the computing device 130 to access the agent 133, web application 131, operating system of the computing device 130, and remote storage 190, the agent 133 may not require separate user credentials if user credentials are entered in the web application 131, etc.

Meanwhile, if user 110 attempts to open a file through the web application 131 when the agent 133 is not activated, the computing device 130 may request the user 110 to perform login processing to activate the agent 133.

In operation 203, the computing device 130 may receive a request from user 110 to open a file through the web application 131.

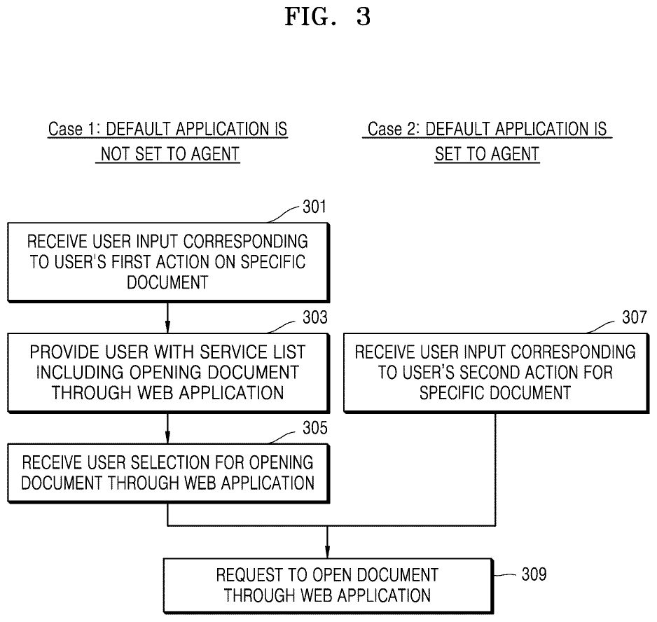

FIG. 3 is a flowchart for explaining a file opening request operation according to embodiments of the present disclosure, which will be further referenced. For convenience of explanation, FIG. 3 uses documents as an example of files, but embodiments of the present disclosure are not limited to being applied only to documents.

When user 110 attempts to open a file according to a preset action for a specific document in the local storage 137, the computing device 130 may receive a request to open the document through the web application 131.

First, an embodiment (Case 1) is described in which the default application for the extension (docx, pptx, xlsx, etc.) of the target document in the operating system of the computing device 130 is not set to the agent 133.

In operations 301 and 303, when the computing device 130 receives user input corresponding to a first action by user 110 for the target document, the computing device 130 may provide user 110 with a service list including opening the document through the web application 131. In operations 305 and 309, if the computing device 130 receives a user selection of opening the document through the web application 131 from user 110, the computing device 130 may recognize that a request to open the document through the web application 131 has been received, and may perform subsequent operations. Here, the first action may include the user 110 positioning the cursor on the target document and right-clicking with the mouse. And, the service list provided to user 110 may be provided as part of a context menu. According to an embodiment, the corresponding service list may be dynamically changed and provided in the context menu depending on the extension of the target document file.

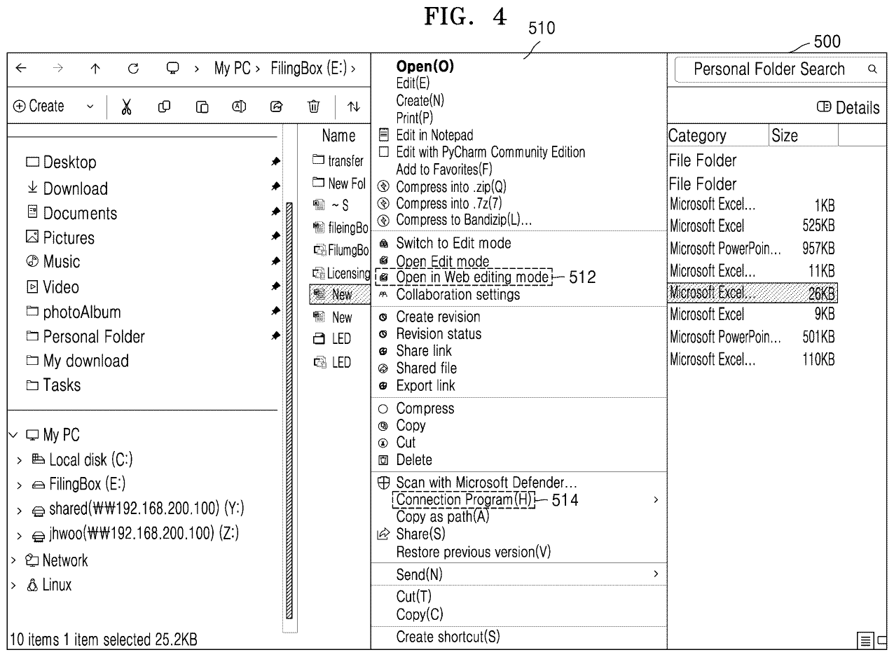

FIG. 4 is an example view of a file opening request operation according to Case 1 of FIG. 3. Referring to the example view of FIG. 4, to describe this embodiment (Case 1) in more detail, a user can manage (view, copy/move, delete, etc.) various files stored in the local storage 137 or network storage through a file manager 500 (e.g., Windows Explorer, Finder in macOS, etc.) provided by the operating system of the computing device 130. Using Windows Explorer as an example of a file manager, the file manager 500 may provide a context menu 510 in response to a user's first action (e.g., right-clicking with a mouse) on a certain file. The context menu 510 may consist of menu items corresponding to various functions available for that file, including, for example, open, edit, print, copy, delete, etc.

As described in FIG. 1, the agent 133 according to an embodiment of the present disclosure may be mounted in the form of a shell extension to the file manager. In this case, the functions provided by the agent 133 may be listed in the context menu 510. In the embodiment of FIG. 4, the functions provided by the agent 133 may include switching editing mode, opening in editing mode, opening in web editing mode 512, setting up collaboration, etc. Among these, the open in web editing mode 512 function may correspond to the aforementioned “opening a file through the web application 131” function.

As user 110 selects the open in web editing mode 512 function among the functions of the agent 133 listed in the context menu 510, the agent 133 may perform isolation processing for that file according to the operations 205 to 211 to be described later.

According to one embodiment, the agent 133 may be implemented as a separate application instead of being mounted in the form of a shell extension. In this case, the agent 133 may be displayed as one of the applications for opening the file through the ‘Open with’ 514 item among the context menu 510 for that file, and subsequent operations 205 to 211 may be performed as the agent 133 is selected by the user.

Next, an embodiment (Case 2) is described in which the default application for the extension of the target document in the operating system of the computing device 130 is set to the agent 133.

In operations 307 and 309, when the computing device 130 receives user input corresponding to a second action by user 110 for the target document, the computing device 130 may recognize that a request to execute opening the document through the web application 131 (opening in web editing mode) among the functions of the agent 133 has been received 309, and may perform subsequent operations.

Here, the second action may include the user 110 positioning the cursor on the target document and double-clicking with the mouse.

To specify the default application executed through double-clicking in advance, when the agent 133 is installed on the computing device 130, the state where the default application (default program) of the operating system for the extension of that document file is changed to the agent 133 may be added. Alternatively, after the agent 133 is installed, the state where the default application for the extension of that document file is set to the agent 133 may be added through the setting function of the operating system.

Referring back to FIG. 2, in operation 205, the computing device 130 may upload the file selected by user 110 from the local storage 137 to the remote storage 190 in response to receiving the request to open the file through the web application 131. At this time, the agent 133 may transmit the account information entered during the agent activation step and/or the authentication token issued after user authentication from the remote storage 190 or web application server 170 to the remote storage 190, and upon completion of authentication, may upload the file to a location (folder, etc.) corresponding to the user account in the remote storage 190.

In operation 207, the computing device 130 may execute opening the file through the web application 131 for the file uploaded to the remote storage 130.

At this time, a web application 131 capable of executing file opening according to the extension name of the uploaded file is used, and the uploaded file may be opened through the interoperation of the web application 131 and the web application server 170.

More specifically, when a file is uploaded to the remote storage 190, the remote storage 190 may provide the path of the uploaded file to the agent 133, and the agent 133 may drive the web application 131 to connect to a pre-designated URL of the web application server 170 including the file location information of the uploaded file in the remote storage 190, allowing the file uploaded to the remote storage 190 to be opened in the web application 131.

According to an embodiment, the pre-designated URL of the web application server 170 may be a URL that the agent 133 has predetermined to correspond to the file extension. Alternatively, the URL may be a single default URL that the web application server 170 dynamically matches according to the extension of the uploaded file to be viewed through the web application server 170.

According to an embodiment, the web application server 170 may access and view the file by referring to the file location information in the remote storage 190 transmitted when attempting to connect from the web application 131, or it may clone the file uploaded to the remote storage 190 to the web application server 170, view it, and then provide it to the web application 131 for editing.

According to an embodiment, before or when the web application 131 attempts to connect to the web application server 170 through the URL, the agent 133 may deliver user authentication information or a pre-issued authentication token to the web application server 170 through the web application 131, and the document to be edited may be displayed to the web application 131 only when authentication is successful.

In some embodiments, the agent 133 may activate an exclusive mode for the file when uploading it to the remote storage 190, restricting applications other than the agent 133 from editing or deleting the file.

According to an embodiment of the present disclosure, the file in the local storage 137 is not directly opened through the local application 135, but is uploaded to the remote storage 190 and then executed through the web application 131 and web application server 170. That is, since malware attached to the file has not been viewed through the local application 135 in the computing device 130, it can prevent direct access to and modification or encryption of files in the local storage 137.

In operation 209, the computing device 130 may download a file processed (worked on) through the web application 131 from the remote storage 190.

The processed file may be a product that has been return-saved to the remote storage 190 with the user 110's editing and changes reflected according to the user 110's termination of the web application 131. However, the technical concept of the present disclosure is not limited to this. The processed file may include intermediate products that are return-saved to the remote storage 190 with the user 110's editing changes reflected at that point in time in case the user 110 directly requests saving during the use of the web application 131 or automatic saving at a certain interval.

In another implementation example, when user 110 terminates the web application 131 after working on a file in the web application 131, the application server 170 may confirm that the connection with the web application 131 is terminated and save the last modified file back to the remote storage 190, and the remote storage 190 may provide the modified file to the agent 133 or provide the agent 133 with information that the file has been modified, allowing the agent 133 to download the file. In operation 211, the agent 133 may update the file stored in the local storage 137 with the file downloaded from the remote storage 190. In other words, the computing device 130 may replace the initial file before user 110 started working with a file that reflects user 110's work and save it in the local storage 137.

Additionally, when user 110 changes the name of a file in the web application 131 and then terminates the web application 131, the application server 170 may confirm that the connection with the web application 131 is terminated and save the last modified file back to the remote storage 190. In this case, both the file before the name change and the file with the changed name may be stored in the remote storage 190. The file with the changed name may correspond to the last modified file, and the file before the name change may correspond to the initially uploaded file, the last modified file, or a file with some modifications reflected before the last modification. The remote storage 190 may provide the modified file to the agent 133 or provide the agent 133 with information that the file has been modified, allowing the agent 133 to download the file, and both files stored in the remote storage 190 may be downloaded simultaneously, with the existing file (the file before the name change) being updated and the file created with a new name in the remote storage 190 being newly created in the local storage 137.

Furthermore, if the agent 133 has opened and uploaded the file in exclusive mode when uploading it to the remote storage 190, the exclusive mode may be deactivated after the file is finally updated in the local storage 137 with the file that reflects the work, allowing the file to be accessed by other application(s).

In the embodiment of the present disclosure, as described above, a file edited remotely on the web through the web application 131 is transferred from the remote storage 190 to the local storage 137, and the original file in the local storage 137 is updated.

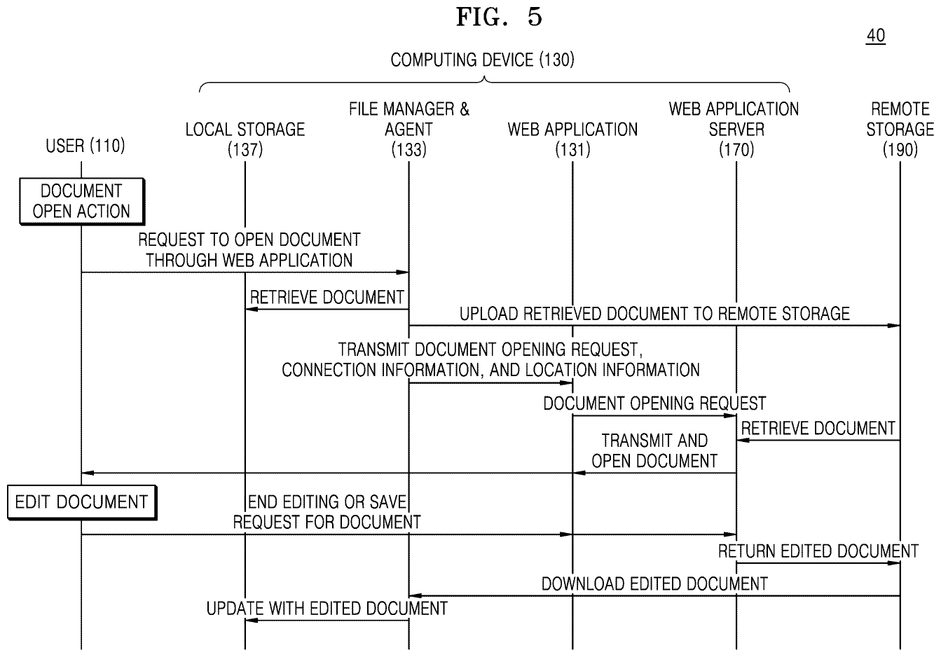

FIG. 5 is a diagram for explaining an operation sequence in a system according to embodiments of the present disclosure. FIG. 5 illustrates an exemplary operation sequence that may occur in the system 10 (FIG. 1) when user 110 (FIG. 1) uses the aforementioned remote file processing method 20 (FIG. 2). In explaining FIG. 5, FIG. 1 through FIG. 4 will be referenced together, but duplicate explanations will be omitted, and the file processing process will be explained from a system perspective. Meanwhile, it should be noted that FIG. 5 illustrates an operation sequence with the agent 133 activated. FIG. 5 also uses documents as an example of files for convenience of explanation, but embodiments of the present disclosure are not limited to being applied only to documents.

First, user 110 attempts to open a specific document among documents in the local storage 137 of computing device 130 through the web application 131. To open a document through the web application 131, different actions may be required from user 110 depending on whether the default application for the extension of the document to be opened is set to the agent 133 (see FIG. 3 and related explanation).

When user 110 makes a request to open a document through the web application 131 that meets a predetermined condition, the agent 133 may retrieve the document from the local storage 137 and upload the retrieved document to the remote storage 190. And, the agent 133 may transmit a document opening request, connection information of the web application 131 for opening the document, information related to the location of the document stored in the remote storage 190, and/or user authentication information in a predetermined manner, etc., to the web application 131 to execute the document opening.

The web application 131 attempts to open the document in conjunction with the web application server 170 based on the received information, and when the web application server 170 delivers the document retrieved from the remote storage 190 to the web application 131, the web application 131 may execute opening the document and provide it to user 110.

When user 110 ends document editing through the web application 131 (or terminates the web application 131) or user 110 requests document saving (or automatic document saving request at any interval), an edited document, which is a product reflecting the editing result, may be returned from the web application server 170 to the remote storage 190.

The agent 133 may download the edited document from the remote storage 190 and update the document in the local storage 137 that existed before editing began with the downloaded edited document.

According to an embodiment, the agent 133 may be configured to receive document opening requests only for document files within a pre-designated local disk volume (e.g., D:, E:, F:, etc.), specific storage area within a local disk (e.g., desktop, downloads, my documents, etc.), or network drive (e.g., \\192.168.200.100, etc.) according to the agent's settings, thereby restricting documents to be edited and viewed through the web application 131 only when they are in a specific location. Additionally, according to an embodiment, when user 110 creates a new file at the specific location through a context menu using a file manager, etc., the agent 133 may also automatically perform the operation of sending the created file to the remote storage 190 and opening it through the web application 131.

According to an embodiment, the agent 133 may edit and view documents through the web application 131 regardless of which local storage 137 the documents exist in within the computing device 130, and when the document in the remote storage 190 is finally updated, the agent 133 may be configured to newly create the edited file in a specific folder within a pre-designated local storage 137, or update the document if the same file exists in that folder.

According to the technical concept of the present disclosure, the agent uploads a file stored in the local storage to a remote storage and opens the file uploaded to the remote storage through a web application in the process of opening the file, thereby preventing the local storage and the computing device including it from being attacked by malware included in the file.

Furthermore, by including an authentication process using an authentication token, etc., when uploading a file to the remote storage or when attempting to open a file through a web application, unauthorized access to files by unauthorized users, etc., can be effectively prevented.

Moreover, when opening a file through a web application is executed by the agent, an exclusive mode for the file stored in the local storage is activated, thereby blocking the file from being changed by other applications.

The effects that can be obtained through the technical concept of the present disclosure are not limited to the effects mentioned above, and other effects not mentioned will be clearly understood by those skilled in the art to which the invention pertains from the following description.

The embodiments of the present disclosure described above can be implemented as a program recorded on a medium that a computer can read as code. The computer-readable medium includes all types of recording devices in which data that can be read by a computer system is stored. Examples of computer-readable media include HDD (Hard Disk Drive), SSD (Solid State Disk), SDD (Silicon Disk Drive), ROM, RAM, CD-ROM, magnetic tape, floppy disk, optical data storage device, etc.

The description and examples of one or more embodiments provided in this specification are not intended to limit or restrict the scope of the claimed technical concept of the present disclosure. The embodiments, examples, and details provided in this specification are considered sufficient to transfer ownership and to configure and use the best mode of the claimed invention. The claimed invention should not be construed as being limited to any embodiment, example, or detail provided in this specification. Various features (structural and methodological), regardless of whether they are shown and described together or separately, may be selectively included or omitted to implement an embodiment with a specific set of features. Given the description and examples provided in this specification, one skilled in the art will be able to devise alterations, modifications, and alternative embodiments that fall within the comprehensive scope of the general concept of the invention embodied herein, without departing from the comprehensive scope of the claimed invention.

1. A method performed by a computing device, comprising:
receiving a request to open a file stored in a local storage of the computing device through a web application;
in response to receiving the request to open the file, by an agent executed in the computing device, uploading the file to a remote storage;
executing file opening through the web application for the uploaded file;
downloading a file processed through the web application from the remote storage; and
updating the file stored in the local storage with the downloaded file.

2. The method of claim 1, wherein the receiving comprises:
receiving user input corresponding to a first action by a user for a file having an extension for which a default application is not set to the agent among files stored in the local storage;
in response to the received user input, providing a service list including opening the file through the web application—wherein opening the file through the web application is a function provided by the agent; and
receiving a request to open the file through the web application based on the service list.

3. The method of claim 1, wherein the receiving comprises:
receiving user input corresponding to a second action by a user for a file having an extension for which a default application is set to the agent among files stored in the local storage.

4. The method of claim 1, wherein the uploading comprises:
transmitting, by the agent, authentication information to the remote storage, the authentication information including at least one of an authentication token issued from the remote storage or a web application server, and account information of the user; and
upon completion of authentication based on the transmitted authentication information, uploading the file to the remote storage.

5. The method of claim 1, wherein the executing comprises:
providing, by the agent, connection information for executing opening the file through the web application for the uploaded file to the web application, and
wherein the connection information includes at least one of location information of the uploaded file in the remote storage, and a URL of a web application server interoperating with the web application.

6. The method of claim 1, wherein the executing comprises:
transmitting, by the agent, authentication information to a web application server, the authentication information including at least one of an authentication token issued from the remote storage or the web application server, and account information of the user; and
upon completion of authentication based on the transmitted authentication information, the uploaded file being provided through the web application.

7. The method of claim 1, wherein the executing further comprises:
activating an exclusive mode that restricts editing or deletion by applications other than the agent for the file stored in the local storage.

8. The method of claim 7, wherein the updating further comprises:
deactivating the exclusive mode after the file stored in the local storage is updated with the downloaded file.

9. A non-transitory computer-readable storage medium storing a program for executing the method of claim 1.

10. A computing device, comprising:
at least one processor; and
a memory storing executable instructions for the at least one processor,
wherein when the instructions are executed by the at least one processor, the at least one processor is configured to:
receive a request to open a file stored in a local storage of the computing device through a web application—wherein opening the file through the web application is a function provided through an agent executed by the at least one processor,
upload the file to a remote storage in response to receiving the request to open the file,
execute opening the file through the web application for the uploaded file,
download a file processed through the web application from the remote storage, and
update the file stored in the local storage with the downloaded file.

11. The computing device of claim 10, wherein the at least one processor is configured to:
receive user input corresponding to a first action by the user for a file having an extension for which a default application is not set to the agent among files stored in the local storage,
in response to the received user input, provide a service list including opening the file through the web application, and
receive a request to open the file through the web application based on the service list.

12. The computing device of claim 10, wherein the at least one processor is configured to receive a request to open the file through the web application by receiving user input corresponding to a second action by the user for a file having an extension for which a default application is set to the agent among files stored in the local storage.

13. The computing device of claim 10, wherein the at least one processor is configured to:
transmit authentication information to the remote storage, the authentication information including at least one of an authentication token issued from the remote storage or a web application server, and account information of the user, and
upload the file to the remote storage upon completion of authentication based on the transmitted authentication information.

14. The computing device of claim 10, wherein the at least one processor is configured to:
transmit authentication information to a web application server, the authentication information including at least one of an authentication token issued from the remote storage or the web application server, and account information of the user, and
the uploaded file is provided through the web application upon completion of authentication based on the transmitted authentication information.

15. The computing device of claim 10, wherein the at least one processor is configured to:
activate an exclusive mode that restricts editing or deletion by applications other than the agent for the file stored in the local storage as opening the file through the web application is executed, and
deactivate the exclusive mode after the file stored in the local storage is updated with the file downloaded from the remote storage.
